(19) United States
(12) Patent Application Publication
(10) Pub. No.: US 2024/0359993 A1
(43) Pub. Date: Oct. 31, 2024

(54) HYDROPHOBIC ORGANIC SOLVENT-DISPERSED SILICA SOL AND METHOD FOR PRODUCING SAME

(71) Applicant: NISSAN CHEMICAL CORPORATION, Tokyo (JP)

(72) Inventors: Keiko YOSHITAKE, Sodegaura-shi (JP); Kazuya KUROIWA, Sodegaura-shi (JP)

(73) Assignee: NISSAN CHEMICAL CORPORATION, Tokyo (JP)

(21) Appl. No.: 18/681,649

(22) PCT Filed: Jul. 27, 2022
(86) PCT No.: PCT/JP2022/029002

§ 371 Date: Jun. 18, 2024

(30) Foreign Application Priority Data
Aug. 6, 2021 (JP) 2021-129554

(51) Int. Cl. C01B 33/149

(52) U.S. Cl. CPC C01B 33/149; C01P 2006/22

(57) ABSTRACT

A silica sol dispersed in a nonaqueous solvent, especially a hydrophobic solvent, to improve the compatibility with organic materials, and method for producing the same; the silica sol containing alkali, in which at least two types of alkoxy groups of Si—OR⁰ and Si—OR¹ (provided that R⁰ is a C₁₋₄ alkyl group, R¹ is a C₂₋₁₀ organic group which arbitrarily has an oxygen atom, and R⁰ and R¹ are not the same chemical group) are present on or near a surface of silane-coated silica particles, the silica particles having a molar ratio (Si—OR¹)/(Si—OR⁰) of 0.17 to 10 are used as dispersoids, and at least one hydrophobic organic solvent selected from the group consisting of ketones, ethers, esters, amides, and hydrocarbons is used as a dispersion medium.

### TECHNICAL FIELD

The present invention relates to a silica sol dispersed in a hydrophobic solvent and a method for producing the same.

### BACKGROUND ART

There have been attempts to improve physical properties of coatings by incorporating silica particles into coating compositions for resins and films and attempts to improve physical properties of cured products by incorporating silica particles into resin matrices. For these, a colloidal silica dispersion (silica sol) is used, but a silica sol (organosilica sol) dispersed in a non-aqueous solvent is used in order to improve compatibility with organic substances.

For example, a method for producing an organic solvent-dispersed inorganic oxide sol including the following processes (A) and (B) has been disclosed (refer to Patent Document 1).
(A) a process of adding a silicon alkoxide having two or more alkoxy groups bonded to silicon atoms or a silicon alkoxide having a hydroxy group bonded to one or more silicon atoms and an alkoxy group bonded to one or more silicon atoms to a hydrophilic inorganic oxide sol containing 25 to 100% by mass of a hydrophilic solvent having a boiling point of 100° C. or less in a dispersion medium and treating the surface of inorganic oxide particles in the sol, and
(B) a process of substituting the dispersion medium of the inorganic oxide sol whose surface is treated that is obtained in the process (A) with a non-alcoholic organic solvent in the co-presence of a C₃₋₁₂ primary alcohol.

In this method, a method in which hydroxy groups on the surface of inorganic oxide particles such as silica react with an alcohol, alkoxy groups are introduced for obtaining an organic compound, and thereby an inorganic oxide sol dispersed in an organic solvent such as toluene is obtained, has been disclosed. For example, a silica sol obtained by reacting a methanol-dispersed silica sol with phenyltrimethoxysilane and dispersing it in a toluene solvent has been disclosed.

A sol (silica sol) in which silica particles having an average particle diameter of 5 to 100 nm in which an organic group containing an unsaturated bond between carbon atoms and an alkoxy group are bonded to the surface are dispersed in a ketone solvent, wherein the organic groups containing an unsaturated bond between carbon atoms (0.5 to 2.0 groups/nm²) and the alkoxy groups (0.1 to 2.0 groups/nm²) are bonded at a molar ratio (organic groups containing an unsaturated bond between carbon atoms)/(alkoxy groups) of 0.5 to 5.0 has been disclosed (refer to Patent Document 2).

A method for producing a hydrophobic silica sol whose pH is increased by treating a hydrophobic silica sol with a pH in an acidic range with an alkali has been disclosed (refer to Patent Document 3).

### PRIOR ART DOCUMENTS

### Patent Documents

Patent Document 1: JP 2005-200294 A

Patent Document 2: WO 2020/230823

Patent Document 3: JP 4-092808 A

### SUMMARY OF THE INVENTION

### Problem to be Solved by the Invention

The present invention provides a silica sol dispersed in a non-aqueous solvent, particularly a hydrophobic solvent in order to improve compatibility with an organic substance, and a method for producing the same. The organosilica sol of the present invention can be treated with a silane on the surface of silica particles, and a silica sol having improved stability due to addition of an amine is provided.

### Means for Solving the Problem

The present invention provides, as a first aspect, a silica sol containing an alkali,
in which at least two types of alkoxy groups of Si—OR⁰ and Si—OR¹ (provided that R⁰ is a C₁₋₄ alkyl group, R¹ is a C₂₋₁₀ organic group which arbitrarily has an oxygen atom, and R⁰ and R¹ are not the same chemical group) are present on or near a surface of silane-coated silica particles,
the silica particles having a molar ratio (Si—OR¹)/(Si—OR⁰) of 0.17 to 10 are used as dispersoids, and
at least one hydrophobic organic solvent selected from the group consisting of ketones, ethers, esters, amides, and hydrocarbons is used as a dispersion medium,
as a second aspect, the silica sol according to the first aspect,
wherein Si—OR⁰ is Si—OCH₃,
as a third aspect, the silica sol according to the first aspect or the second aspect,
wherein the silica particles have an average particle diameter of 5 to 200 nm determined by a dynamic light scattering method,
as a fourth aspect, the silica sol according to the first aspect,
wherein R¹ is an ethyl group, n-propyl group, isopropyl group, n-butyl group, isobutyl group, s-butyl group, t-butyl group, 1-methoxy-2-propyl group, 1-ethoxy-2-propyl group, or phenyl group,
as a fifth aspect, the silica sol according to any one of the first aspect to the fourth aspect,
wherein a silane coating of the silica particles is a hydrolysate of at least one silane compound selected from the group consisting of Formula (1) to Formula (3):

R³ₐSi(R⁴)₄₋ₐ Formula (1)

[R⁵_{b}Si(R⁶)_{3-b}]₂ Y_{c} Formula (2)

R⁷ₐSi(R⁸)_{4-d} Formula (3)

(in Formula (1), each R³ is an alkyl group, a halogenated alkyl group, an alkenyl group, an aryl group, or an organic group having an epoxy group, a (meth)acryloyl group, a mercapto group, an amino group, a ureido group, or a cyano group and is bonded to a silicon atom through a Si—C bond, each R⁴ is an alkoxy group, an acyloxy group, or a halogen group, and a is an integer of 1 to 3, and
in Formula (2) and Formula (3), each of R⁵ and R⁷ is a C₁₋₃ alkyl group or a C₆₋₃₀ aryl group and is bonded to a silicon atom through a Si—C bond, each of R⁶ and R⁸ is an alkoxy group, an acyloxy group, or a halogen group, Y is an alkylene group, an NH group, or an oxygen atom, b is an integer of 1 to 3, c is an integer of 0 or 1, and d is an integer of 1 to 3),
as a sixth aspect, the silica sol according to any one of the first aspect to the fifth aspect,
wherein the silica sol contains at least one alkali among amines, quaternary ammonium hydroxides, alkali metal hydroxides, alkali metal alkoxides, alkali metal salts of aliphatic carboxylic acids, and alkali metal salts of aromatic carboxylic acids,
as a seventh aspect, the silica sol according to the sixth aspect,
wherein a measured pH of a liquid obtained by mixing the alkali-containing silica sol, methanol, and pure water at a mass ratio of 1:1:1 to 1:2:1 is 4.0 to 9.5, and
as an eighth aspect, a method for producing the silica sol according to any one of the first aspect to the seventh aspect, the method comprising the following process (A) to process (C), the following process (A-1) that is a process before the process (C) and after completion of the process (A), and the following process (A-2) that is a process before completion of all the processes and after completion of the process (A-1):
a process (A): a process of obtaining a silica sol containing the silica particles having an average particle diameter of 5 to 200 nm determined by a dynamic light scattering method and using a C₁₋₄ alcohol R⁰OH (provided that R⁰ is a C₁₋₄ alkyl group) as a dispersion medium,
a process (B): a process of removing some or all of R⁰OH from the silica sol obtained in the process (A) and adding an alcohol having an R¹OH structure (provided that R¹ is a C₂₋₁₀ organic group which arbitrarily has an oxygen atom, and R⁰ and R¹ are not the same chemical group),
a process (C): a process of removing some or all of alcohols having R⁰OH and R¹OH structures from the silica sol obtained in the process (B) and adding at least one hydrophobic organic solvent selected from the group consisting of ketones, ethers, esters, amides, and hydrocarbons,
a process (A-1): a process of covering the silica sol obtained in the process (A) with at least one silane compound of Formula (1) to Formula (3), and
a process (A-2): a process of adding at least one alkali among amines, quaternary ammonium hydroxides, alkali metal hydroxides, alkali metal alkoxides, alkali metal salts of aliphatic carboxylic acids, and alkali metal salts of aromatic carboxylic acids to the silica sol obtained in the process (A-1).

### Effects of the Invention

Hydrophobic organic solvents such as ketones, ethers, esters, amides, and hydrocarbons have a high utility value as solvents used in many applications, including applications for dilution of paints, inks, and adhesives, reaction solvents for pharmaceuticals and agricultural chemicals, basic raw materials for derivatives, and washing agents.

On the other hand, there have been attempts to improve physical properties of coatings by incorporating silica particles into coating compositions for resins and films and attempts to improve physical properties of cured products by incorporating silica particles into resin matrices.

When improvement in performance is attempted by incorporating silica particles in various applications, since the silica particles are used as colloid particles, aggregation of silica powder is inevitable, and the particles in the form of a colloidal silica dispersion (silica sol) are added to a resin and the like, and in this case, a silica sol dispersed in an organic solvent with high compatibility with the resin is used.

The present invention provides a silica sol dispersed in a hydrophobic organic solvent such as a ketone, ether, ester, amide, or hydrocarbon, which has a high utility value as a solvent.

An organosilica sol is generally produced by dispersing a silica sol (aqueous silica sol) in an aqueous solvent, a dispersion medium is solvent-substituted with a lower alcohol (for example, methanol) instead of water and additionally substituted with desired hydrophobic organic solvents such as a ketone, ether, ester, amide, and hydrocarbon, and thus a silica sol using hydrophobic organic solvents such as a ketone, ether, ester, amide, and hydrocarbon as a dispersion medium is obtained.

Silica particles have silanol groups on or near the surface, and when the dispersion medium is substituted with methanol instead of water, hydroxyl groups of the silanol are converted into methoxy groups. In addition, before the dispersion medium is substituted with hydrophobic organic solvents such as a ketone, ether, ester, amide, and hydrocarbon instead of methanol, the solvent is substituted with a high-boiling-point alcohol, and a silica sol in hydrophobic organic solvents such as a ketone, ether, ester, amide, and hydrocarbon is obtained. Accordingly, at least two types of alkoxy groups are present in silanol groups on or near the surface of silica particles. For example, there are at least two types of alkoxy groups: methoxy groups and alkoxy groups of high-boiling-point alcohols.

The abundance proportion of these at least two types of alkoxy groups greatly influences the stability of a silica sol using hydrophobic organic solvents such as a ketone, ether, ester, amide, and hydrocarbon as a dispersion medium.

In the silica sol using hydrophobic organic solvents such as a ketone, ether, ester, amide, and hydrocarbon as a dispersion medium, the surface of silica particles is covered with a silane compound, and functional groups that are not converted into silanol are bonded by covalent bonds, which contributes to the stability of the silica sol using hydrophobic organic solvents such as a ketone, ether, ester, amide, and hydrocarbon as a dispersion medium.

### MODES FOR CARRYING OUT THE INVENTION

The present invention provides a silica sol containing an alkali, in which at least two types of alkoxy groups of Si—OR⁰ and Si—OR¹ (provided that R⁰ is a C₁₋₄ alkyl group, R¹ is a C₂₋₁₀ organic group which may have an oxygen atom, and R⁰ and R¹ are not the same chemical group) are present on or near the surface of silane-coated silica particles, the silica particles having a molar ratio (Si—OR¹)/(Si—OR⁰) of 0.17 to 10 are used as dispersoids, and at least one hydrophobic organic solvent selected from the group consisting of ketones, ethers, esters, amides, and hydrocarbons is used as a dispersion medium.

In Si—OR⁰ and Si—OR¹, R⁰ and R¹ are not the same chemical group. That is, if Si—OR⁰ is Si—OCH₃, in Si—OR¹, R¹ is other than a methyl group and is a C₂₋₁₀ organic group which may have an oxygen atom.

In addition, the number of carbon atoms can also have the relationship of R⁰<R¹. When the number of carbon atoms has the relationship of R⁰<R¹, in the relationship between Si—OR⁰ and Si—OR¹, if Si—OR⁰ is Si—OCH₃, in Si—OR¹, R¹ is an organic group having a carbon atom number of 2 or more, and is a C₂₋₁₀ organic group which may have an oxygen atom.

Si—OR⁰ includes an alkoxy group generated by a reversible reaction between the hydroxyl group of the silanol group on or near the surface of silica particles and R⁰OH when the aqueous medium which is a dispersion medium of an aqueous silica sol is substituted with a C₁₋₄ alcohol R⁰OH (provided that R⁰ is a C₁₋₄ alkyl group), and an alkoxy group that is not bonded to polyfunctional silane particles bonded to the particles or one generated by a reversible reaction between the hydroxyl group and a C₁₋₄ alcohol R⁰OH in the medium.

Si—OR⁰ can indicate, for example, Si—OCH₃, Si—OC₂H₅, or Si—OC₃H₇. Particularly, Si—OCH₃ is a preferable example.

In addition, the Si—OR¹ group (provided that R¹ is a C₂₋₁₀ organic group which may have an oxygen atom, and R⁰ and R¹ are not the same chemical group) includes an alkoxy group that is reversibly generated between Si—OH or Si—OR⁰ and an alcohol having an R¹OH structure when R⁰OH of the dispersion medium is substituted with an alcohol having an R¹OH structure (provided that R¹ is a C₂₋₁₀ organic group which may have an oxygen atom).

In the present invention, silica particles have a molar ratio (Si—OR¹)/(Si—OR⁰) of 0.17 to 10, and particularly, silica particles having a molar ratio (Si—OR¹)/(Si—OCH₃) of 0.17 to 10 are preferable.

In at least one hydrophobic organic solvent selected from the group consisting of ketones, ethers, esters, amides, and hydrocarbons, the ketone is a linear or cyclic aliphatic ketone having a carbon atom number of 3 to 30, and examples thereof include methyl ethyl ketone, diethyl ketone, methyl propyl ketone, methyl isobutyl ketone, diisopropyl ketone, diisobutyl ketone, methyl amyl ketone, and cyclohexanone. The ether is a linear or cyclic aliphatic ether having a carbon atom number of 3 to 30, and examples thereof include diethylether and tetrahydrofuran. The ester is a linear or cyclic ester having a carbon atom number of 2 to 30, and examples thereof include ethyl acetate, n-butyl acetate, sec-butyl acetate, methoxybutyl acetate, amyl acetate, n-propyl acetate, isopropyl acetate, ethyl lactate, butyl lactate, ethylene glycol monomethyl ether acetate, propylene glycol monomethyl ether acetate, propylene glycol monoethyl ether acetate, propylene glycol monopropyl ether acetate, phenyl acetate, phenyl lactate, and phenyl propionate. The amide is a C₃₋₃₀ aliphatic amide, and examples thereof include dimethylacetamide, dimethylformamide, N-methylpyrrolidone, and N-ethylpyrrolidone. The hydrocarbon is a linear or cyclic aliphatic or aromatic hydrocarbon having a carbon atom number of 6 to 30, and examples thereof include hexane, heptane, octane, nonane, decane, benzene, toluene, and xylene.

In the R¹OH structure alcohol, R¹ is a C₂₋₁₀ organic group which may have an oxygen atom, and the oxygen atom can be present in the form of an ether bond or hydroxy group.

Examples of R¹ include ethyl group, n-propyl group, i-propyl group, n-butyl group, isobutyl group, s-butyl group, t-butyl group, n-pentyl group, i-pentyl group, 1-methoxy-2-propyl group, 1-ethoxy-2-propyl group, 1-propoxy-2-propyl group, 2-ethoxyethyl group, 2-hydroxyethyl group, 1-hydroxy-2-ethyl group, 3-methoxybutyl group, and phenyl group. For R¹, ethyl group, n-propyl group, isopropyl group, n-butyl group, isobutyl group, s-butyl group, t-butyl group, 1-methoxy-2-propyl group, 1-ethoxy-2-propyl group, and phenyl group can be preferably used.

Examples of R¹OH structure alcohols include ethanol, n-propanol, i-propanol, n-butanol, isobutanol, s-butanol, t-butanol, n-pentanol, ethylene glycol, ethylene glycol monomethylether, propylene glycol monomethyl ether, propylene glycol monoethylether, and propylene glycol monopropyl ether.

The sol of the present invention has a solid content of 0.1 to 60% by mass, or 1 to 55% by mass, or 10 to 55% by mass. Here, the solid content is obtained by removing the solvent component from all components of the sol.

In the sol of the present invention, the average particle diameter (determined by a dynamic light scattering method (DLS method)) of silica particles is in a range of 5 to 200 nm or 5 to 150 nm, and the average primary particle diameter of silica particles observed under a transmission electron microscope is in a range of 5 to 200 nm, 5 to 150 nm, or 5 to 100 nm.

The silica sol of the present invention is obtained through the following process (A) to process (C):
a process (A): a process of obtaining a silica sol containing the silica particles having an average particle diameter of 5 to 200 nm determined by a dynamic light scattering method and using a C₁₋₄ alcohol R⁰OH (provided that R⁰ is a C₁₋₄ alkyl group) as a dispersion medium,
a process (B): a process of removing some or all of R⁰OH from the silica sol obtained in the process (A) and adding an alcohol having an R¹OH structure (provided that R¹ is a C₂₋₁₀ organic group which may have an oxygen atom, and R⁰ and R¹ are not the same chemical group), and
a process (C): a process of removing some or all of alcohols having R⁰OH and R¹OH structures from the silica sol obtained in the process (B) and adding at least one hydrophobic organic solvent selected from the group consisting of ketones, ethers, esters, amides, and hydrocarbons.

A silica sol using methanol as a dispersion medium is obtained using an aqueous silica sol as a starting raw material. The aqueous silica sol is obtained using water glass as a starting raw material through a) a process of cation-exchanging water glass to obtain activated silica and b) a process of heating the activated silica to obtain silica particles. In the a) process, an activated silica in which, in order to increase the purity of the activated silica, a mineral acid (for example, hydrochloric acid, nitric acid, or sulfuric acid) is added, metal impurities other than silica are eluted, and metal impurities and unnecessary anions are removed by cation exchange and anion exchange can be used. In the b) process, an alkali component (for example, NaOH, KOH) is added to the activated silica to grow silica particles. In order to promote growth of silica particles, a seed liquid in which an alkali is added to the activated silica obtained in the a) process and a feed liquid are prepared, and while heating the seed liquid, the feed liquid is supplied to increase the particle diameter of silica and thus an aqueous silica sol having an arbitrary particle diameter can be obtained.

More preferably, an acidic silica sol in which, of the alkali component added in the b) process, alkali ions existing outside the particles are removed, is suitable as a starting raw material of the present invention.

In the process (A) of the present invention, it is possible to obtain a silica sol containing the silica particles having an average particle diameter of 5 to 200 nm determined by a dynamic light scattering method, and using a C₁₋₄ alcohol R⁰OH (provided that R⁰ is a C₁₋₄ alkyl group) as a dispersion medium.

A process (B): a process of removing some or all of R⁰OH from the silica sol obtained in the process (A) and adding an alcohol having an R¹OH structure (provided that R¹ is a C₂₋₁₀ organic group which may have an oxygen atom, and R⁰ and R¹ are not the same chemical group). In addition, the number of carbon atoms can also have the relationship of R⁰<R¹.

Removal of some or all of R⁰OH and addition of an alcohol having an R¹OH structure are also so-called solvent substitution, but it is not necessary to completely remove R⁰OH, it is possible to remove R⁰OH in the subsequent process, and some R⁰OH can remain. Removal of R⁰OH and addition of an alcohol having an R¹OH structure can both be performed at the same time or either one can be performed first.

These can be performed by an evaporation method or ultrafiltration method. For example, the silica sol using R⁰OH obtained in the process (A) as a dispersion medium is put into a flask in a warm bath at 50 to 100° C., the alcohol having the R¹OH structure (provided that R¹ is a C₂₋₁₀ organic group which may have an oxygen atom, and R⁰ and R¹ are not the same chemical group) can be added at a liquid temperature of 40 to 90° C. in the flask to perform solvent substitution. Solvent substitution can be performed under normal pressure or under reduced pressure. It can be performed under reduced pressure, for example, at a pressure of 50 to 600 Torr. The time required for solvent substitution can be about 0.1 to 10 hours.

A process (C): a process of removing some or all of alcohols having R⁰OH and R¹OH structures from the silica sol obtained in the process (B) and adding at least one hydrophobic organic solvent selected from the group consisting of ketones, ethers, esters, amides, and hydrocarbons.

Removal of some or all of alcohols having R⁰OH (particularly, methanol) and R¹OH structures and addition of at least one hydrophobic organic solvent selected from the group consisting of ketones, ethers, esters, amides, and hydrocarbons are also so-called solvent substitution, but it is not necessary to completely remove methanol and an alcohol having an R¹—OH structure, and some methanol and an alcohol having an R¹OH structure can remain. These can be performed by an evaporation method. Removal of alcohols having R⁰OH (particularly, methanol) and R¹OH structures and addition of at least one hydrophobic organic solvent selected from the group consisting of ketones, ethers, esters, amides, and hydrocarbons can both be performed at the same time or either one can be performed first.

The following process (A-1) can be provided before the process (C) after the process (A) is completed:

The process (A-1): a process of covering the silica sol obtained in the process (A) with a hydrolysate of at least one silane compound selected from the group consisting of those of Formula (1) to Formula (3) can be performed. Here, the process (A-1) can be performed again after the process (A-2).

In Formula (1), each R³ is an alkyl group, a halogenated alkyl group, an alkenyl group, an aryl group, or an organic group having an epoxy group, a (meth)acryloyl group, a mercapto group, an amino group, a ureido group, or a cyano group and is bonded to a silicon atom through a Si—C bond, each R⁴ is an alkoxy group, an acyloxy group, or a halogen group, a is an integer of 1 to 3,
in Formula (2) and Formula (3), each of R⁵ and R⁷ is a C₁₋₃ alkyl group or a C₆₋₃₀ aryl group and is bonded to a silicon atom through a Si—C bond, each of R⁶ and R⁸ is an alkoxy group, an acyloxy group, or a halogen group, Y is an alkylene group, an NH group, or an oxygen atom, b is an integer of 1 to 3, c is an integer of 0 or 1, and d is an integer of 1 to 3.

The alkyl group is a C₁₋₁₈ alkyl group, and examples thereof include methyl group, ethyl group, n-propyl group, i-propyl group, cyclopropyl group, n-butyl group, i-butyl group, s-butyl group, t-butyl group, cyclobutyl group, 1-methyl-cyclopropyl group, 2-methyl-cyclopropyl group, n-pentyl group, 1-methyl-n-butyl group, 2-methyl-n-butyl group, 3-methyl-n-butyl group, 1,1-dimethyl-n-propyl group, 1,2-dimethyl-n-propyl group, 2,2-dimethyl-n-propyl group, 1-ethyl-n-propyl group, cyclopentyl group, 1-methyl-cyclobutyl group, 2-methyl-cyclobutyl group, 3-methyl-cyclobutyl group, 1,2-dimethyl-cyclopropyl group, 2,3-dimethyl-cyclopropyl group, 1-ethyl-cyclopropyl group, 2-ethyl-cyclopropyl group, n-hexyl group, 1-methyl-n-pentyl group, 2-methyl-n-pentyl group, 3-methyl-n-pentyl group, 4-methyl-n-pentyl group, 1,1-dimethyl-n-butyl group, 1,2-dimethyl-n-butyl group, 1,3-dimethyl-n-butyl group, 2,2-dimethyl-n-butyl group, 2,3-dimethyl-n-butyl group, 3,3-dimethyl-n-butyl group, 1-ethyl-n-butyl group, 2-ethyl-n-butyl group, 1,1,2-trimethyl-n-propyl group, 1,2,2-trimethyl-n-propyl group, 1-ethyl-1-methyl-n-propyl group, 1-ethyl-2-methyl-n-propyl group, cyclohexyl group, 1-methyl-cyclopentyl group, 2-methyl-cyclopentyl group, 3-methyl-cyclopentyl group, 1-ethyl-cyclobutyl group, 2-ethyl-cyclobutyl group, 3-ethyl-cyclobutyl group, 1,2-dimethyl-cyclobutyl group, 1,3-dimethyl-cyclobutyl group, 2,2-dimethyl-cyclobutyl group, 2,3-dimethyl-cyclobutyl group, 2,4-dimethyl-cyclobutyl group, 3,3-dimethyl-cyclobutyl group, 1-n-propyl-cyclopropyl group, 2-n-propyl-cyclopropyl group, 1-i-propyl-cyclopropyl group, 2-i-propyl-cyclopropyl group, 1,2,2-trimethyl-cyclopropyl group, 1,2,3-trimethyl-cyclopropyl group, 2,2,3-trimethyl-cyclopropyl group, 1-ethyl-2-methyl-cyclopropyl group, 2-ethyl-1-methyl-cyclopropyl group, 2-ethyl-2-methyl-cyclopropyl group, 2-ethyl-3-methyl-cyclopropyl group, hexyl group, heptyl group, octyl group, nonyl group, decyl group, undecyl group, dodecyl group, tridecyl group, tetradecyl group, pentadecyl group, hexadecyl group, heptadecyl group, and octadecyl group, but the present invention is not limited thereto.

In addition, the alkylene group may be an alkylene group derived from the above alkyl group.

Examples of halogenated alkyl groups include groups in which the hydrogen atom of the alkyl group is substituted with a halogen atom such as fluorine, chlorine, bromine, or iodine.

The aryl group is a C₆₋₃₀ aryl group, and examples thereof include phenyl group, naphthyl group, anthracene group, and pyrene group.

The alkenyl group is a C₂₋₁₀ alkenyl group, and examples thereof include an ethenyl group, 1-propenyl group, 2-propenyl group, 1-methyl-1-ethenyl group, 1-butenyl group, 2-butenyl group, 3-butenyl group, 2-methyl-1-propenyl group, 2-methyl-2-propenyl group, 1-ethylethenyl group, 1-methyl-1-propenyl group, 1-methyl-2-propenyl group, 1-pentenyl group, 2-pentenyl group, 3-pentenyl group, 4-pentenyl group, 1-n-propylethenyl group, 1-methyl-1-butenyl group, 1-methyl-2-butenyl group, 1-methyl-3-butenyl group, 2-ethyl-2-propenyl group, 2-methyl-1-butenyl group, 2-methyl-2-butenyl group, 2-methyl-3-butenyl group, 3-methyl-1-butenyl group, 3-methyl-2-butenyl group, 3-methyl-3-butenyl group, 1,1-dimethyl-2-propenyl group, 1-i-propylethenyl group, 1,2-dimethyl-1-propenyl group, 1,2-dimethyl-2-propenyl group, 1-cyclopentenyl group, 2-cyclopentenyl group, 3-cyclopentenyl group, 1-hexenyl group, 2-hexenyl group, 3-hexenyl group, 4-hexenyl group, 5-hexenyl group, 1-methyl-1-pentenyl group, 1-methyl-2-pentenyl group, 1-methyl-3-pentenyl group, 1-methyl-4-pentenyl group, 1-n-butylethenyl group, 2-methyl-1-pentenyl group, and 2-methyl-2-pentenyl group, but the present invention is not limited thereto.

Examples of alkoxy groups include a C₁₋₁₀ alkoxy group, such as a methoxy group, ethoxy group, n-propoxy group, i-propoxy group, n-butoxy group, i-butoxy group, s-butoxy group, t-butoxy group, n-pentyloxy group, 1-methyl-n-butoxy group, 2-methyl-n-butoxy group, 3-methyl-n-butoxy group, 1,1-dimethyl-n-propoxy group, 1,2-dimethyl-n-propoxy group, 2,2-dimethyl-n-propoxy group, 1-ethyl-n-propoxy group, and n-hexyloxy group, but the present invention is not limited thereto.

The acyloxy group is a C₂₋₁₀ acyloxy group, and examples thereof include methylcarbonyloxy group, ethylcarbonyloxy group, n-propylcarbonyloxy group, i-propylcarbonyloxy group, n-butyl carbonyloxygroup, i-butyl carbonyloxygroup, s-butyl carbonyloxygroup, t-butyl carbonyloxygroup, n-pentylcarbonyloxy group, 1-methyl-n-butyl carbonyloxygroup, 2-methyl-n-butyl carbonyloxygroup, 3-methyl-n-butyl carbonyloxygroup, 1,1-dimethyl-n-propylcarbonyloxy group, 1,2-dimethyl-n-propylcarbonyloxy group, 2,2-dimethyl-n-propylcarbonyloxy group, 1-ethyl-n-propylcarbonyloxy group, n-hexyl carbonyloxy group, 1-methyl-n-pentylcarbonyloxy group, and 2-methyl-n-pentylcarbonyloxy group, but the present invention is not limited thereto.

Examples of halogen groups include fluorine, chlorine, bromine, and iodine.

Examples of organic groups having an epoxy group include 2-(3,4-epoxycyclohexyl) ethyl group and 3-glycidoxypropyl group.

The (meth)acryloyl group represents both an acryloyl group and a methacryloyl group. Examples of organic groups having a (meth)acryloyl group include 3-methacryloxypropyl group and 3-acryloxypropyl group.

Examples of organic groups having a mercapto group include 3-mercaptopropyl group.

Examples of organic groups having an amino group include 2-aminoethyl group, 3-aminopropyl group, N-2-(aminoethyl)-3-aminopropyl group, N-(1,3-dimethyl-butylidene) aminopropyl group, N-phenyl-3-aminopropyl group, and N-(vinylbenzyl)-2-aminoethyl-3-aminopropyl group.

Examples of organic groups having an ureido group include 3-ureidopropyl group.

Examples of organic groups having a cyano group include 3-cyanopropyl group.

Formula (2) and Formula (3) are preferably compounds that can form a trimethylsilyl group on the surface of the silica particles.

Examples of these compounds are listed below.

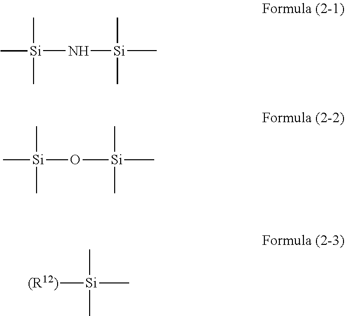

In the above formula, R¹² is an alkoxy group, and examples thereof include methoxy group and ethoxy group.

This is a process in which the silane compound reacts with a hydroxy group on the surface of silica particles, for example, a silanol group in the case of silica particles, to cover the surface of the silica particles with the silane compound through a siloxane bond. The reaction temperature can be from 20° C. to a boiling point of the dispersion medium, and for example, the reaction can be performed in a range of 20° C. to 100° C. The reaction can be performed for a reaction time of about 0.1 to 6 hours.

In addition to the trimethylsilyl group, examples of preferable functional groups in Formula (2) and Formula (3) include monomethylsilyl group, dimethylsilyl group, methacryloxypropylsilyl group, and phenyl group, and examples of corresponding silane compounds include trimethylmethoxysilane, trimethylethoxysilane, hexamethyldisilazane, hexamethyldisiloxane, methyltrimethoxysilane, dimethyldimethoxysilane, methyltriethoxysilane, methacryloxypropyltrimethoxysilane, methacryloxypropyltriethoxysilane, acryloxypropyltrimethoxysilane, acryloxypropyltriethoxysilane, phenyltrimethoxysilane, and phenyltriethoxysilane.

Regarding the amount of the silane compound for covering the surface of silica particles, a silane compound corresponding to a coating amount in which the number of silicon atoms in the silane compound is 0.1 atoms/nm² to 6.0 atoms/nm² can be added to the silica sol to cover the surface of silica particles.

Water is required for hydrolysis of the silane compound, but if the sol is in an aqueous solvent, such an aqueous solvent is used, and if the sol is a C₁₋₃ alcohol solvent, water remaining in the alcohol solvent when the aqueous medium is solvent-substituted with an R⁰OH alcohol can be used. The residual water is water remaining when the sol of the aqueous medium is solvent-substituted with the sol of a C₁₋₃ alcohol solvent. For example, water present in the alcohol at 1% by mass or less, for example, 0.01 to 1% by mass, can be used. In addition, hydrolysis can be performed with or without a catalyst.

When hydrolysis is performed without a catalyst, the surface of silica particles may be on the acidic side, and a methanol silica sol having a pH of 2 to 6 (measured when methanol and water are contained at 1:1) can be used.

When a catalyst is used, examples of hydrolysis catalysts include metal chelate compounds, organic acids, inorganic acids, organic bases, and inorganic bases. Examples of metal chelate compounds as hydrolysis catalysts include triethoxy-mono(acetylacetonato) titanium, and triethoxy-mono(acetylacetonato) zirconium. Examples of organic acids as hydrolysis catalysts include acetic acid and oxalic acid. Examples of inorganic acids as hydrolysis catalysts include hydrochloric acid, nitric acid, sulfuric acid, hydrofluoric acid, and phosphoric acid. Examples of organic bases as hydrolysis catalysts include pyridine, pyrrole, piperazine, and quaternary ammonium salts. Examples of inorganic bases as hydrolysis catalysts include ammonia, sodium hydroxide, and potassium hydroxide.

The present invention can include the following process (A-2) before all the processes are completed after the process (A-1) is completed:

The process (A-2): a process of adding at least one alkali among amines, quaternary ammonium hydroxides, alkali metal hydroxides, alkali metal alkoxides, alkali metal salts of aliphatic carboxylic acids, and alkali metal salts of aromatic carboxylic acids to the silica sol obtained in the process (A-1).

The amount of an alkali added is preferably an amount at which the pH of the silica sol is 4.0 to 9.5. The amount of the alkali added is present as a content in the silica sol. The pH of the hydrophobic organic solvent silica sol of the present invention is determined by measuring a liquid obtained by mixing a silica sol, methanol, and pure water at a mass ratio of 1:1:1 to 1:2:1.

Examples of amines include secondary amines and tertiary amines having a total number of carbon atoms of 5 to 35.

Examples of the aforementioned secondary amines include ethyl-n-propylamine, ethylisopropylamine, dipropylamine, diisopropylamine, ethylbutylamine, n-propylbutylamine, dibutylamine, ethylpentylamine, n-propylpentylamine, isopropylpentylamine, dipentylamine, ethyloctyl amine, i-propyloctyl amine, butyloctylamine, and dioctylamine.

Examples of the aforementioned tertiary amines include triethylamine, ethyl-di-n-propylamine, diethyl-n-propylamine, tri-n-propylamine, triisopropylamine, ethyldibutylamine, diethylbutylamine, isopropyldibutylamine, diisopropylethylamine, diisopropylbutylamine, tributylamine, ethyldipentylamine, diethylpentylamine, tripentylamine, methyldioctylamine, dimethyloctyl amine, ethyldioctylamine, diethyloctyl amine, trioctyl amine, benzyldibutylamine, and diazabicycloundesene.

Among the above amines, secondary amines and tertiary amines having an alkyl group having a total number of carbon atoms of 6 to 35 are preferable, and examples thereof include diisopropylamine, tripentylamine, triisopropylamine, dimethyloctyl amine, and trioctyl amine.

The quaternary ammonium hydroxide is preferably a tetraalkylammonium hydroxide having a total number of carbon atoms of 4 to 40. Examples thereof include tetramethylammonium hydroxide, tetraethylammonium hydroxide, tetra-n-propylammonium hydroxide, tetra-i-propylammonium hydroxide, tetrabutylammonium hydroxide, and ethyltrimethylammonium hydroxide.

Examples of alkali metal hydroxides include sodium hydroxide, potassium hydroxide, sodium carbonate, and potassium carbonate.

Examples of alkali metal alkoxides include sodium methoxide, sodium ethoxide, potassium methoxide, and potassium ethoxide.

Examples of alkali metal salts of aliphatic carboxylic acids include alkali metal salts of saturated aliphatic carboxylic acids having a carbon atom number of 2 to 30, and alkali metal salts of unsaturated aliphatic carboxylic acids. Examples of alkali metals include sodium and potassium. Examples of alkali metal salts of saturated aliphatic carboxylic acids include alkali metal laurates, alkali metal myristates, alkali metal palmitates, and alkali metal stearates.

Examples of alkali metal salts of unsaturated aliphatic carboxylic acids include alkali metal salts of oleic acid, alkali metal salts of linoleic acid, and alkali metal salts of linolenic acid.

Particularly, alkali metal salts of unsaturated aliphatic carboxylic acids such as potassium oleate are preferably used.

Examples of alkali metal salts of aromatic carboxylic acids include benzoates, salicylates, and phthalates.

In the present invention, since the silica sol uses at least one hydrophobic organic solvent selected from the group consisting of ketones, ethers, esters, amides, and hydrocarbons as a dispersion medium, it is preferable that the silica particles have irreversible hydrophobic groups on the surface. Therefore, it is preferable to perform coating with a hydrolysate of at least one of silane compounds of Formula (1) to Formula (3). This silane coating is preferably performed on the acidic side.

Then, some silanol groups on or near the surface of silica particles are converted into Si—OR⁰ groups in the R⁰OH solvent, but when the R¹OH solvent is added to the R⁰OH solvent, R⁰O-groups and the remaining silanol groups are converted into R¹O-groups. In addition, when substituted with at least one hydrophobic organic solvent selected from the group consisting of ketones, ethers, esters, amides, and hydrocarbons, the ratio of R¹OH/R⁰OH in the sol increases, and thus R⁰O-groups and the remaining silanol groups are converted into alkoxy R¹O-groups. This reaction is promoted on the acidic side, but is inhibited by adding the amine, and silica particles having a molar ratio (Si—OR¹)/(Si—OR⁰) of 0.17 to 10 and particularly a molar ratio (Si—OR¹)/(Si—OCH₃) of 0.17 to 10 are obtained.

The present invention provides a silica sol dispersed in at least one hydrophobic organic solvent selected from the group consisting of ketones, ethers, esters, amides, and hydrocarbons, and can be used for, for example, adhesives, mold release agents, semiconductor encapsulants, LED encapsulants, paints, film internal additives, hard coating agents, photoresist materials, printing inks, washing agents, cleaners, various resin additives, insulating compositions, anti-rust agents, lubricating oils, metal processing oils, film coating agents, and release agents.

### EXAMPLES

### Analysis Method of Particle-Bonded Alcohol

20 ml of n-hexane was added to 4 ml of a sample, and after centrifugation (2770G), the supernatant was removed and the precipitate was separated. In addition, after the precipitate was re-dissolved by adding 2 to 4 ml of acetone, an operation of adding n-hexane again until aggregation occurred and separating the precipitate by centrifugation (2770G) was performed twice. The obtained precipitate was vacuum-dried at 150° C. to obtain a dry powder.

0.2 g of the powder obtained above was mixed with 10 ml of a 0.05 N sodium hydroxide aqueous solution and left at room temperature for 1 day. Then, if there was any undissolved material, it was removed by filtration or centrifugation, the solution portion was subjected to gas chromatography measurement, and thus the amount of the alcohol bonded on the surface was measured.

### Example 1

A methanol silica sol (with an average primary particle diameter of 22 nm, a silica concentration of 40.6% by mass, and 2.4% of water, commercially available from Nissan Chemical Corporation) was prepared.

1,200 g of the methanol sol was put into a 2 L eggplant flask, and while stirring the sol with a magnetic stirrer, 120 g of n-butyl alcohol and 32.3 g of methacryloxypropyltrimethoxysilane (product name KBM-503, commercially available from Shin-Etsu Chemical Co., Ltd.) were added, and the mixture was then maintained at a liquid temperature of 60° C. for 2 hours. Then, 1.95 g of diisopropylamine was added, and the liquid temperature was then raised to 67° C., and maintained for 1 hour. In addition, 12.3 g of methacryloxypropyltrimethoxysilane was added, and the mixture was maintained at a liquid temperature of 67° C. for 1 hour.

Then, methyl isobutyl ketone (MIBK) was supplied while the solvent was distilled off by evaporation in a rotary evaporator at a decompression degree of 480 to 125 Torr and a bath temperature of 80° C., the dispersion medium of the sol was substituted with MIBK, and filtering was performed through a filter paper with an average pore size of 1 um to obtain a transparent colloid-colored MIBK-dispersed silica sol (40.5% by mass of SiO₂, a viscosity (20° C.) of 2.8 mPa·s, 0.03% by mass of water, 0.1% by mass of methanol, 5% by mass of n-butyl alcohol, an average particle diameter of 23 nm of silica particles determined by a dynamic light scattering method, an amount of methacryloxy groups bonded to silica particles of 1.4 groups/nm², an amount of methoxy groups bonded to silica particles of 0.5 groups/nm², and an amount of butoxy groups bonded to silica particles of 0.36 groups/nm²). The molar ratio (Si—OC₄H₉)/(Si—OCH₃) was 0.72.

The pH of a liquid obtained by mixing the sol, methanol, and pure water at a mass ratio of 1:1:1 was measured with a pH meter and found to be 9.0.

Even after this sol was put into a sealed glass container and maintained at 50° C. for 4 weeks, there was no increase in viscosity.

### Example 2

A water-dispersed silica sol (with an average primary particle diameter of 12 nm, a pH of 3, and a silica concentration of 33% by mass, commercially available from Nissan Chemical Corporation) was prepared.

1,000 g of the silica sol was put into a glass reactor with an internal volume of 2 L including a stirrer, a condenser, a thermometer and two inlets, and while the sol in the reactor was still boiling, methanol vapor generated in another boiler was continuously blown into the silica sol in the reactor, and water was substituted with methanol while gradually raising the liquid level. When the volume of the distillate reached 9 L, the substitution was completed, and 1,100 g of a methanol-dispersed silica sol was obtained. The obtained methanol-dispersed silica sol had a SiO₂ concentration of 30.5% by mass, 1.6% by mass of water, and a viscosity of 2 mPa·s.

1,000 g of the methanol sol was put into a 1 L eggplant flask, and while stirring the sol with a magnetic stirrer, 150 g of n-butyl alcohol and 77.5 g of methyltrimethoxysilane (product name KBM-13, commercially available from Shin-Etsu Chemical Co., Ltd.) were added, and the mixture was then maintained at a liquid temperature of 60° C. for 5 hours. Then, n-butyl acetate was supplied while the solvent was distilled off by evaporation in a rotary evaporator at a decompression degree of 500 to 80 Torr and a bath temperature of 80° C., the dispersion medium of the sol was substituted with n-butyl acetate, and 0.6 g (0.9 mmol per 100 g of SiO₂ of silica particles) of tri-n-pentylamine was then added to obtain a transparent colloid-colored n-butyl acetate-dispersed silica sol (40.5% by mass of SiO₂, a viscosity (20° C.) of 3.2 mPa·s, 0.02% by mass of water, 0.02% by mass of methanol, 4% by mass of n-butyl alcohol, an average particle diameter (determined by a dynamic light scattering method) of 19 nm of silica particles measured after dilution with n-butyl acetate, an amount of methyl groups bonded to silica particles of 1.4 groups/nm², an amount of methoxy groups bonded to silica particles of 0.44 groups/nm², and an amount of butoxy groups bonded to silica particles of 0.71 groups/nm²). The molar ratio (Si—OC₄H₉)/(Si—OCH₃) was 1.61.

The pH of a liquid obtained by mixing the silica sol, methanol, and pure water at a mass ratio of 1:2:1 was measured with a pH meter and found to be 5.3.

Even after this sol was put into a sealed glass container and maintained at 50° C. for 4 weeks, there was no increase in viscosity.

### Example 3

A water-dispersed silica sol (with an average primary particle diameter of 12 nm, a pH of 3, and a silica concentration of 33% by mass, commercially available from Nissan Chemical Corporation) was prepared.

1,000 g of the silica sol was put into a glass reactor with an internal volume of 2 L including a stirrer, a condenser, a thermometer and two inlets, and while the sol in the reactor was still boiling, methanol vapor generated in another boiler was continuously blown into the silica sol in the reactor, and water was substituted with methanol while gradually raising the liquid level. When the volume of the distillate reached 9 L, the substitution was completed, and 1,100 g of a methanol-dispersed silica sol was obtained. The obtained methanol-dispersed silica sol had a SiO₂ concentration of 30.5% by mass, 1.6% by mass of water, and a viscosity of 2 mPa·s.

800 g of the methanol sol was put into a 1 L eggplant flask, and while stirring the sol with a magnetic stirrer, 57 g of n-butyl alcohol and 52.8 g of methyltrimethoxysilane (product name KBM-13, commercially available from Shin-Etsu Chemical Co., Ltd.) were added, and the mixture was maintained at a liquid temperature of 60° C. for 5 hours. Then, 15.2 g of dimethyldimethoxysilane (product name KBM-22, commercially available from Shin-Etsu Chemical Co., Ltd.) was added, and the mixture was maintained at a liquid temperature of 60° C. for 3 hours. After cooling, 0.48 g (0.9 mmol per 100 g of SiO₂ of silica particles) of tripentylamine was added, and cyclohexanone was supplied while the solvent was distilled off by evaporation in a rotary evaporator at a decompression degree of 500 to 70 Torr and a bath temperature of 80 to 90° C., and the dispersion medium of the sol was substituted with cyclohexanone to obtain a colorless and transparent cyclohexanone-dispersed silica sol (38% by mass of SiO₂, a viscosity (20° C.) of 12 mPa·s, 0.04% by mass of water, 0.2% by mass of methanol, 2% by mass of n-butyl alcohol, an average particle diameter (determined by a dynamic light scattering method) of 22 nm of silica particles measured after dilution with methyl ethyl ketone (MEK), an amount of methyl groups bonded to silica particles of 1.4 groups/nm², an amount of methoxy groups bonded to silica particles of 0.49 groups/nm², and an amount of butoxy groups bonded to silica particles of 0.15 groups/nm²). The molar ratio (Si—OC₄H₉)/(Si—OCH₃) was 0.31.

The pH of a liquid obtained by mixing the silica sol, methanol, and pure water at a mass ratio of 1:1:1 was measured with a pH meter and found to be 4.8.

Even after this sol was put into a sealed glass container and maintained at 50° C. for 4 weeks, there was no increase in viscosity or particle diameter (determined by a dynamic light scattering method).

### Example 4

A water-dispersed silica sol (with an average primary particle diameter of 12 nm, a pH of 3, and a silica concentration of 33% by mass, commercially available from Nissan Chemical Corporation) was prepared.

1,000 g of the silica sol was put into a glass reactor with an internal volume of 2 L including a stirrer, a condenser, a thermometer and two inlets, and while the sol in the reactor was still boiling, methanol vapor generated in another boiler was continuously blown into the silica sol in the reactor, and water was substituted with methanol while gradually raising the liquid level. When the volume of the distillate reached 12 L, the substitution was completed, and 1,100 g of a methanol-dispersed silica sol was obtained. The obtained methanol-dispersed silica sol had a SiO₂ concentration of 30.5% by mass, 0.5% by mass of water, and a viscosity of 2 mPa·s.

1,000 g of the methanol-dispersed silica sol was put into a 1 L eggplant flask, and while stirring the sol with a magnetic stirrer, 100 g of n-butyl alcohol, and 34.2 g of phenyltrimethoxysilane (product name KBM-103, commercially available from Shin-Etsu Chemical Co., Ltd.) were added and the mixture was then maintained at a liquid temperature of 60° C. for 2 hours. Next, 46.3 g of hexamethyldisiloxane (product name KF-96L, commercially available from Shin-Etsu Chemical Co., Ltd.) was added, and the mixture was then maintained at a liquid temperature of 60° C. for 2 hours.

After cooling, 0.92 g (0.8 mmol per 100 g of SiO₂ of silica particles) of trioctyl amine was added, diisopropyl ketone was supplied while the solvent was distilled off by evaporation in a rotary evaporator at a decompression degree of 450 to 120 Torr and a bath temperature of 80° C., and the dispersion medium of the sol was substituted with diisopropyl ketone to obtain a colorless and transparent diisopropyl ketone-dispersed silica sol (50.5% by mass of SiO₂, a viscosity (20° C.) of 7.5 mPa·s, 0.02% by mass of water, 0.1% by mass of methanol, 3% by mass of n-butyl alcohol, an average particle diameter (determined by a dynamic light scattering method) of 16 nm of silica particles measured after dilution with diisobutyl ketone, an amount of phenyl groups bonded to silica particles of 0.8 groups/nm², an amount of methoxy groups bonded to silica particles of 0.45 groups/nm², and an amount of butoxy groups bonded to silica particles of 0.47 groups/nm²). The molar ratio (Si—OC₄H₉)/(Si—OCH₃) was 1.04.

The pH of a liquid obtained by mixing the silica sol, methanol, and pure water at a mass ratio of 1:1:1 was measured with a pH meter and found to be 7.2.

After this sol was put into a sealed glass container and maintained at 50° C. for 4 weeks, the viscosity (20° C.) was 7.5 mPa·s, the particle diameter (determined by a dynamic light scattering method) of silica particles was 16 nm, and the storage stability was favorable.

### Comparative Example 1

A transparent colloid-colored MIBK-dispersed silica sol (40.5% by mass of SiO₂, a viscosity (20° C.) of 2.0 mPa·s, 0.05% by mass of water, 0.1% by mass of methanol, an average particle diameter of 21 nm of silica particles determined by a dynamic light scattering method, an amount of methacryloxy groups bonded to silica particles of 1.4 groups/nm², and an amount of methoxy groups bonded to silica particles of 0.5 groups/nm²) was obtained in the same operation as in Example 1 except that no n-butyl alcohol was added.

The pH of a liquid obtained by mixing the silica sol, methanol, and pure water at a mass ratio of 1:1:1 was measured with a pH meter and found to be 9.0.

This sol was put into a sealed glass container and had an initial viscosity of 2.0 mPa·s, and an average particle diameter of 21 nm of silica particles determined by a dynamic light scattering method, but after being maintained at 50° C. for 4 weeks, the viscosity was 2.2 mPa·s, and the average particle diameter of silica particles determined by a dynamic light scattering method was 27 nm. The stability of the silica sol was not sufficient.

### Comparative Example 2

A transparent colloid-colored n-butyl acetate-dispersed silica sol (40.5% by mass of SiO₂, a viscosity (20° C.) of 3.2 mPa·s, 0.02% by mass of water, 0.02% by mass of methanol, 4% by mass of n-butyl alcohol, an average particle diameter (determined by a dynamic light scattering method) of 20 nm of silica particles measured after dilution with n-butyl acetate, an amount of methoxy groups bonded to silica particles of 0.42 groups/nm², and an amount of butoxy groups bonded to silica particles of 0.70 groups/nm²) was obtained in the same manner as in Example 2 except that no amine was added after substitution with n-butyl acetate. The molar ratio (Si—OC₄H₉)/(Si—OCH₃) was 1.67.

The pH of a liquid obtained by mixing the silica sol, methanol, and pure water at a mass ratio of 1:2:1 was measured with a pH meter and found to be 3.5.

This sol was put into a sealed glass container, had an initial viscosity of 3.2 mPa·s, and an average particle diameter of 20 nm of silica particles determined by a dynamic light scattering method, but after being maintained at 50° C. for 4 weeks, the viscosity was 6.0 mPa·s, the average particle diameter of silica particles determined by a dynamic light scattering method increased to 37 nm, and the stability of the silica sol was not sufficient.

### Comparative Example 3

A diisopropyl ketone-dispersed silica sol (50.5% by mass of SiO₂, a viscosity (20° C.) of 8.6 mPa·s, 0.02% by mass of water, 0.1% by mass of methanol, 3% by mass of n-butyl alcohol, an average particle diameter (determined by a dynamic light scattering method) of 22 nm of silica particles measured after dilution with diisobutyl ketone, an amount of phenyl groups bonded to silica particles of 0.8 groups/nm², an amount of methoxy groups bonded to silica particles of 0.44 groups/nm², and an amount of butoxy groups bonded to silica particles of 0.49 groups/nm²) was obtained in the same manner as in Example 4 except that no amine was added after substitution with diisopropyl ketone. The molar ratio (Si—OC₄H₉)/(Si—OCH₃) was 1.11.

The pH of a liquid obtained by mixing the silica sol, methanol, and pure water at a mass ratio of 1:1:1 was measured with a pH meter and found to be 4.6.

This sol was put into a sealed glass container, had an initial viscosity 8.6 mPa·s, and an average particle diameter of 22 nm of silica particles determined by a dynamic light scattering method, but after being maintained at 50° C. for 2 weeks, the viscosity was 19 mPa·s, and the average particle diameter of silica particles determined by a dynamic light scattering method was 54 nm. The stability of the silica sol was not sufficient.

### Industrial Applicability

There are provided a silica sol dispersed in a non-aqueous solvent, particularly a hydrophobic solvent, in order to improve compatibility with an organic substance, and a method for producing the same.

1. A silica sol containing an alkali,
in which at least two types of alkoxy groups of Si—OR⁰ and Si—OR¹ (provided that R⁰ is a C₁₋₄ alkyl group, R¹ is a C₂₋₁₀ organic group which arbitrarily has an oxygen atom, and R⁰ and R¹ are not the same chemical group) are present on or near a surface of silane-coated silica particles,
the silica particles having a molar ratio (Si—OR¹)/(Si—OR⁰) of 0.17 to 10 are used as dispersoids, and
at least one hydrophobic organic solvent selected from the group consisting of ketones, ethers, esters, amides, and hydrocarbons is used as a dispersion medium.

2. The silica sol according to claim 1,
wherein Si—OR⁰ is Si—OCH₃.

3. The silica sol according to claim 1,
wherein the silica particles have an average particle diameter of 5 to 200 nm determined by a dynamic light scattering method.

4. The silica sol according to claim 1,
wherein R¹ is an ethyl group, n-propyl group, isopropyl group, n-butyl group, isobutyl group, s-butyl group, t-butyl group, 1-methoxy-2-propyl group, 1-ethoxy-2-propyl group, or phenyl group.

5. The silica sol according to claim 1,
wherein a silane coating of the silica particles is a hydrolysate of at least one silane compound selected from the group consisting of Formula (1) to Formula (3):
R³ₐSi(R⁴)₄₋ₐ Formula (1)
[R⁵_{b}Si(R⁶)_{3-b}]₂ Y_{c} Formula (2)
R⁷ₐSi(R⁸)_{4-d} Formula (3)
(in Formula (1), each R³ is an alkyl group, a halogenated alkyl group, an alkenyl group, an aryl group, or an organic group having an epoxy group, a (meth)acryloyl group, a mercapto group, an amino group, a ureido group, or a cyano group and is bonded to a silicon atom through a Si—C bond, each R⁴ is an alkoxy group, an acyloxy group, or a halogen group, and a is an integer of 1 to 3, and
in Formula (2) and Formula (3), each of R⁵ and R⁷ is a C₁₋₃ alkyl group or a C₆₋₃₀ aryl group and is bonded to a silicon atom through a Si—C bond, each of R⁶ and R⁸ is an alkoxy group, an acyloxy group, or a halogen group, Y is an alkylene group, an NH group, or an oxygen atom, b is an integer of 1 to 3, c is an integer of 0 or 1, and d is an integer of 1 to 3).

6. The silica sol according to claim 1,
wherein the silica sol contains at least one alkali among amines, quaternary ammonium hydroxides, alkali metal hydroxides, alkali metal alkoxides, alkali metal salts of aliphatic carboxylic acids, and alkali metal salts of aromatic carboxylic acids.

7. The silica sol according to claim 6,
wherein a pH of a liquid obtained by mixing the alkali-containing silica sol, methanol, and pure water at a mass ratio of 1:1:1 to 1:2:1 is 4.0 to 9.5.

8. A method for producing the silica sol according to claim 1, the method comprising
the following process (A) to process (C), the following process (A-1) that is a process before the process (C) and after completion of the process (A), and the following process (A-2) that is a process before completion of all the processes and after completion of the process (A-1):
a process (A): a process of obtaining a silica sol containing the silica particles having an average particle diameter of 5 to 200 nm determined by a dynamic light scattering method, and using a C₁₋₄ alcohol R⁰OH (provided that R⁰ is a C₁₋₄ alkyl group) as a dispersion medium,
a process (B): a process of removing some or all of R⁰OH from the silica sol obtained in the process (A) and adding an alcohol having an R¹OH structure (provided that R¹ is a C₂₋₁₀ organic group which arbitrarily has an oxygen atom, and R⁰ and R¹ are not the same chemical group),
a process (C): a process of removing some or all of alcohols having R⁰OH and R¹OH structures from the silica sol obtained in the process (B) and adding at least one hydrophobic organic solvent selected from the group consisting of ketones, ethers, esters, amides, and hydrocarbons,
a process (A-1): a process of covering the silica sol obtained in the process (A) with at least one silane compound of Formula (1) to Formula (3), and
a process (A-2): a process of adding at least one alkali among amines, quaternary ammonium hydroxides, alkali metal hydroxides, alkali metal alkoxides, alkali metal salts of aliphatic carboxylic acids, and alkali metal salts of aromatic carboxylic acids to the silica sol obtained in the process (A-1).
